(19) United States
(12) Patent Application Publication
(10) Pub. No.: US 2012/0240829 A1
(43) Pub. Date: Sep. 27, 2012

(54) Multi Component Dye System For Protection of Valuables

(75) Inventor: Sonny Van Dessel, Haacht (BE)

(73) Assignee: 3SI Security Systems N.V., Zaventem (BE)

(21) Appl. No.: 13/514,502

(22) PCT Filed: Dec. 8, 2010
(86) PCT No.: PCT/EP2010/069171

§ 371 Date: Jun. 7, 2012

(30) Foreign Application Priority Data
Dec. 8, 2009 (EP) 09178392.8

(51) Int. Cl. E05G 1/14; B05B 7/00

(52) U.S. Cl. 109/25; 239/303

(57) ABSTRACT

A multi-component dye unit for use in a system to protect valuables. The unit comprises at least two reservoirs arranged in an external container or housing. The reservoirs are filled with different agents A and B, and connected to a spraying device capable of staining the contents of a secured container. The reservoirs are preferably made of flexible material and the contents thereof may be expelled by gas pressure in said external container. Advantageously, the external container may be made of two parts clippable together.

### CROSS REFERENCE TO RELATED APPLICATIONS

This application is the national phase filing of international patent application No. PCT/EP2010/069171, filed Dec. 8, 2010, and claims priority of European patent application number 09178392.8, filed Dec. 8, 2009, the entireties of which applications are incorporated herein by reference.

### BACKGROUND OF THE INVENTION

The invention relates to the protection of valuables in a secured container, fixed (such as a safe or an ATM (Automatic Teller Machine)) or transportable (such as a Cash-in-Transit container) wherein, in case of unauthorized intrusion, a device is activated to produce the spraying of a dye which will irreversibly stain the valuables, thus functioning as a deterrent.

It is known that some security systems for protection of valuables make use of single component dye systems. Examples of such systems are disclosed in EP 0 623 902 A2, UK 2 350 152, U.S. Pat. No. 5,485,143 or EP 0 914 538 B1.

It has been observed, however, that the chance that criminals “crack” the single component dye technology systems in the future (for example by washing out ink under particular physico-chemical conditions) is increasing with time, despite the complexity of the systems. There is thus a need to improve the safety of the protection and/or to make it more difficult for unauthorized users to “crack” the system.

### SUMMARY OF THE INVENTION

It has now been found that multi-component systems are more effective at improving the safety of the protection and/or making it more difficult for unauthorized users to “crack” the system. The purpose of the invention is to replace the currently used single component dye systems by a multi component dye system.

According to the invention, a multi component dye system may advantageously be used in order to increase the level of difficulty of “cracking” the systems, and thus improve the protection of the valuables stored inside the relevant container. According to the present invention, the following embodiments may be contemplated, without the invention being limited to such embodiments:

a. Use of two or more different agents, at least two of which already having their independent final performance characteristics. An example of such embodiment may consist in the combination of ink and glue, ink and a polyurethane or the combination of ink and acid; the ink will stain the valuables, the acid may attack or even decompose them; the glue and/or the polyurethane will glue them together, thus rendering them unusable.

b. Use of multi-component agents that result in one final agent with improved (e.g. more stable) performance characteristics after mixture of all components. An example of such embodiment may consist in a multicomponent ink or multi-component glue.

c. A combination of above embodiments a and b.

The invention will be better understood from the following description in connection with the drawings, provided only as non-limitative examples.

### BRIEF DESCRIPTION OF THE DRAWINGS

FIG. 1 is an exploded view showing the different parts of a dye unit according to one embodiment of the invention;

FIG. 2 shows the assembled dye unit of FIG. 1;

FIG. 3 shows an arrangement according to another embodiment of the invention.

### DETAILED DESCRIPTION OF THE INVENTION

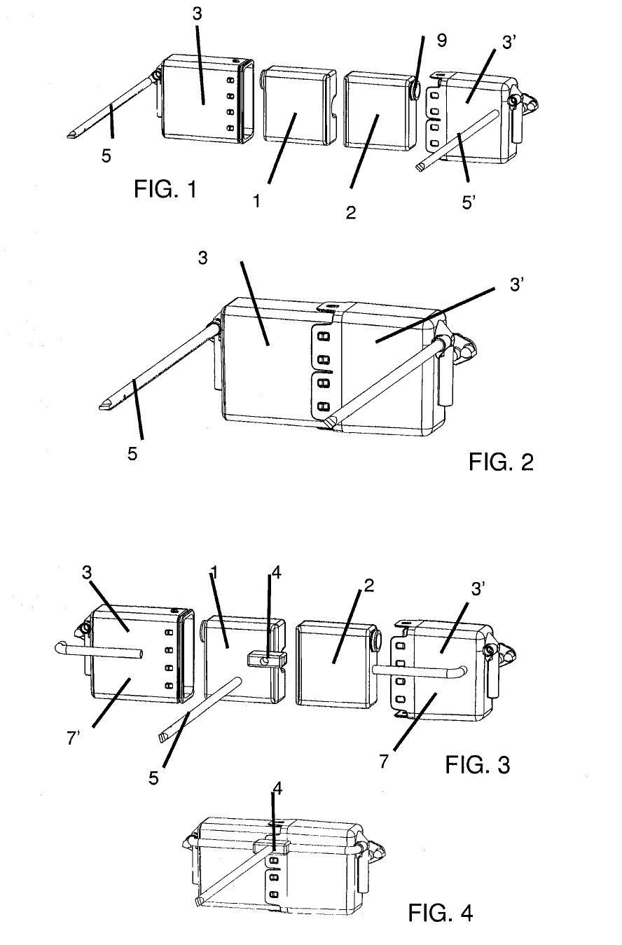

According to a first embodiment of the invention, there is provided a device for two dye agents, as shown in FIG. 1.

FIG. 1 is an exploded perspective view of a dye unit showing the relevant component parts; said dye unit contains two reservoirs (1,2) filled with different agents, in this case dye agents, each being connected to a spray device, such as a spray bar (5,5′) or nozzle delivering the corresponding dye agent onto the valuable (not illustrated) in a container (not illustrated).

The left inner container 1 contains dye agent A. The right inner container 2 contains dye agent B. Both inner containers fit in the left and right outer containers 3 and 3′. According to a preferred embodiment, these outer containers 3 and 3′ are clipped together to form the complete dye unit as per the invention. It is well understood that the outer container constitutes an outer housing for the relevant inner container and may be arranged wherever appropriate but preferably inside the secured container.

The moment an activation (generally via electronic means not part of the present invention) takes place, dye agent A in inner container 1 is projected onto the valuables via the left spray device 5. Dye agent B of inner container 2 is projected on the valuables via the right spray device 5′. Agents A and B are selected such as to provide complementary effects and to avoid any substantial antagonistic effect in the sense of reducing the effect of the one or the other agent.

The activation is operated in a manner generally known in the art, for example by using a pressurized gas to squeeze out and expel the content of the inner containers such as further described in EP 0 914 538, which is entirely incorporated herein by reference. Each inner container may be connected to a pressurized gas container. In the alternative, and if appropriate, a single pressurized gas container may be used to squeeze out and expel the content of both inner containers 1 and 2.

Both agents A and B will each exhibit their specific characteristics, preferably dye characteristics, onto the valuables. Even assuming one is able to “crack” the dye characteristics from one of the agents, say agent A, for example, by a specific leaching technique, the dye characteristics from agent B remain still intact. In the alternative, if one of the agents reinforces or stabilizes the dying characteristics of the other agent, the “cracking” of the system becomes more difficult and/or time consuming, thus discouraging the theft in the first place or the recovery of the valuables from the safe or container containing them.

Tests have been performed using a “Sun Blue” ink (trade name for a dye product sold by 3S1 Security) in combination with cyanoacrylate adhesive agent. Valuables got stained blue and glued at least partially together, thus being rendered unusable.

As shown in FIGS. 3 and 4, one may use two semi-dye agent components, as described above.

The left inner container 1 will contain semi-dye agent component A. The right inner container 2 will contain semi-dye agent component B.

Both inner containers fit in the left and right outer containers 3 and 3′. These outer containers 3 and 3′ are clipped together to form the assembled dye unit.

The moment an activation takes place, semi-dye agent A of the inner container 1 and semi-dye agent B of the inner container 2 are expelled and mixed in the mixing chamber 4 before the final composite dye agent is projected on the valuables through the spray device 5. Conduits 9 lead the content of both inner containers to said mixing chamber 4, which in turn is connected to a single spraying device 5 to spray the mixed dye agent onto the valuables.

According to a preferred embodiment of the invention, the system or any of the agents may further include a nucleic acid marker (DNA tagger) known in the art, which allows for tracing the origin of the stained valuables.

1. A multi-component dye unit for use in a system to protect valuables contained in a secured container, the dye unit comprising at least a first reservoir filled with a first agent and a second reservoir filled with a second agent different than the first agent, and each connected to at least one spraying device for spraying said first and second agents to thereby stain the contents of said secured container,
wherein said first and second reservoirs are disposed within an external container or housing.

2. The unit of claim 1, wherein the first and second reservoirs each comprise a flexible material that permits the contents thereof to be squeezed out and expelled by gas pressure in said external container.

3. The unit of claim 1, wherein the external container comprises two parts clippable together.

4. The unit of claim 1, wherein the spraying device comprises two separate spraying devices each connected to one of the first or second reservoirs.

5. The unit of claim 1, wherein the spraying device comprises a plurality of conduits leading the contents of the first and second reservoirs to a mixing chamber connected to a single spraying device.

6. The unit of claim 1, wherein the first and second agents comprise semi-dye components.

7. The unit of claim 1, wherein the first agent comprises an ink comprising a dye and the second agent comprises a glue, a polyurethane or an acid, or a stabilizer or fixing agent for the first agent.

8. The unit of claim 1, further comprising a nucleic acid marker, either as one of the first or second agents or as part of at least one of the first or second agents.

9. A secured container for protecting valuables, the container comprising the multi-component dye unit of claim 1.

10. The unit of claim 2, wherein the external container comprises two parts clippable together.

11. The unit of claim 2, wherein the spraying device comprises two separate spraying devices each connected to one of the first or second reservoirs.

12. The unit of claim 11, wherein the first agent comprises an ink comprising a dye and the second agent comprises a glue, a polyurethane or an acid, or a stabilizer or fixing agent for the first agent.

13. The unit of claim 3, wherein the spraying device comprises two separate spraying devices each connected to one of the first or second reservoirs.

14. The unit of claim 10, wherein the spraying device comprises two separate spraying devices each connected to one of the first or second reservoirs.

15. The unit of claim 2, wherein the spraying device comprises a plurality of conduits leading the contents of the first and second reservoirs to a mixing chamber connected to a single spraying device.

16. The unit of claim 15, wherein the first and second agents comprise semi-dye components.

17. The unit of claim 3, wherein the spraying device comprises a plurality of conduits leading the contents of the first and second reservoirs to a mixing chamber connected to a single spraying device.

18. The unit of claim 10, wherein the spraying device comprises a plurality of conduits leading the contents of the first and second reservoirs to a mixing chamber connected to a single spraying device.

19. The unit of claim 2, further comprising a nucleic acid marker, either as one of the first or second agents or as part of at least one of the first or second agents.

20. The secured container of claim 9, wherein the first and second reservoirs of the multi-component dye unit each comprise a flexible material that permits the contents thereof to be squeezed out and expelled by gas pressure in said external container and the external container comprises two parts clippable together.
